(19) United States
(12) Patent Application Publication
(10) Pub. No.: US 2024/0396413 A1
(43) Pub. Date: Nov. 28, 2024

(54) METHOD AND SYSTEMS FOR IMAGE SEGMENTING AND JOINING

(71) Applicant: II-VI Delaware, Inc., Wilmington, DE (US)

(72) Inventor: Eric KALLENBACH, Ahrensfelde (DE)

(21) Appl. No.: 18/323,904

(22) Filed: May 25, 2023

(51) Int. Cl. H02K 15/00; B23K 31/02; G06T 7/12; G06T 7/136

(52) U.S. Cl. CPC H02K 15/0081; B23K 31/02; G06T 7/12; G06T 7/136; G06T 2207/20081; G06T 2207/30152

(57) ABSTRACT

A method for joining materials, comprising: providing two materials; placing a first portion of a first material adjacent to a second portion of a second material; taking a digital image of the first and second portions by an imaging sensor; converting the digital image into a tensor, the tensor comprising first, second, and third dimensions, wherein the first dimension comprises a height of the digital image, the second dimension comprises a width of the digital image, and the third dimension comprises a number of digital channels of the imaging sensor, entering the tensor into a trained neural network (NN); outputting a segmentation mask by the NN, determining a joining point using the segmentation mask; and joining the first and second material at the joining point.

### BACKGROUND

Computer Aides Welding (CAW) uses computers to improve welding quality and productivity. Computer Vision (CV) is one aspect of CAW, using imaging and digital image processing to automate various welding tasks, such as seam tracking and quality inspection. CV-methods can improve consistency, precision, reduce rework, and enable real time monitoring of the welding process. Joining two materials by computer aided welding (CAW) requires determining appropriate points at which the materials are to be joined together (joining point). CV is required to analyze, identify and separate respective regions within digital imagery. The task of identify and separate respective regions is called “segmentation” in CV.

The subject matter of the application is directed to a method for joining of materials.

### BRIEF SUMMARY

Disclosed herein are methods and systems for segmenting and joining materials. In one aspect of the disclosure, a method for joining materials includes providing two materials, placing a first portion of a first material adjacent to a second portion of a second material, taking a digital image of the first and second portions by an imaging sensor, converting the digital image into a tensor, the tensor comprising at least first, second, and third dimensions, where the first dimension comprises a height of the digital image, the second dimension comprises a width of the digital image, and the third dimension comprises a number of digital channels of the imaging sensor, entering the tensor into a trained neural network (NN), outputting a segmentation mask by the NN, determining a joining point using the segmentation mask, and joining the first and second material at the joining point. In another aspect of the disclosure, a first and/or second materials comprise a metal. In another aspect of the disclosure, the joining comprises welding, brazing, and/or soldering. In another aspect of the disclosure, welding comprises gas welding, arc welding, resistance welding, energy beam welding, or ultrasonic welding. In another aspect of the disclosure, the first and/or second material comprises a wire. In another aspect of the disclosure, a joining point is determined by thresholding, connected-components, contours, morphological segmentation, or Gaussian mixture. In another aspect of the disclosure, thresholding comprises histogram shape-based thresholding, clustering-based thresholding, entropy-based thresholding, object attribute-based thresholding, and spatial thresholding. In yet another aspect of the disclosure, a digital image is segmented by at least one of semantic segmentation, panoptic segmentation, and instance segmentation.

In one aspect of the disclosure, a joining point is determined by determining at least one of a distance (gap), a convexity, a boundary contour, and a centroid (center point) of the first and second portions. In another aspect of the disclosure, an artificial neural network is trained using deep learning. In another aspect of the disclosure, a NN comprises training at least one of a convolutional NN, a Fully Convolutional Neural Network (FCN), a Vision Transformer (ViT), and a SNN. In another aspect of the disclosure, training comprises reducing an error associated with the training set.

In one aspect of the disclosure, a first and second material are electrically conductive hairpins, and the joining includes hairpin welding for manufacturing a stator, where placing a first portion of a first material adjacent to a second portion of a second material includes introducing the hairpins into a stator such that portions of adjacent hairpins are placed adjacent to each other, determining a joining point includes determining a shape and an orientation of the portions placed adjacent to each other from the segmentation mask, and joining the first and second material comprises welding the joining points to form a stator winding from the welded hairpins. In another aspect of the disclosure, digital images are taken from cross sections of the portions placed adjacent to each other. In another aspect of the disclosure, the methods may include preprocessing the digital image by normalizing cropping, and/or scaling the digital image. In another aspect of the disclosure, the NN is an artificial NN or a spiking neural network.

Disclosed herein are systems for joining materials. In one aspect of the disclosure a system includes a holder adapted to hold at least a first and a second material, such that a first portion of the first material is placed adjacent to a second portion of the second material, a camera adapted to take digital images of the first and second portions, an image processing computer adapted to process the digital images into a segmentation mask using a neural network (NN), and to determine joining points of the materials, and a joining apparatus adapted to join the first and second material at the joining points. In another aspect of the disclosure, a joining apparatus is a welding apparatus, brazing apparatus, or soldering apparatus. In another aspect of the disclosure, a welding apparatus is a gas welding apparatus, arc welding apparatus, resistance welding apparatus, energy beam welding apparatus, or ultrasonic welding apparatus. In another aspect of the disclosure, a holder is a stator with holes that hold electrically conductive hairpins parallel to one another such that portions of adjacent hairpins are placed adjacent to each other, and the joining apparatus is a hairpin welding apparatus.

### BRIEF DESCRIPTION OF THE DRAWINGS

FIG. 1 shows an automated joining system, according to one or more embodiments.

FIG. 2 shows a flowchart of the method steps for joining materials, according to one or more embodiments.

FIG. 3A shows a hairpin, according to one or more embodiments.

FIG. 3B shows two hairpins placed adjacent to each other, according to one or more embodiments.

FIG. 4A shows a digital image of two cross sections of the portions of two adjacent hairpins, according to one or more embodiments.

FIG. 4B shows a segmentation mask of the digital image of FIG. 4A, according to one or more embodiments.

FIG. 5A shows a stator of an electric motor, according to one or more embodiments.

FIG. 5B shows the stator of FIG. 5A and the portions of two adjacent hairpins, according to one or more embodiments.

FIG. 5C shows the portions of FIG. 5B placed next to each other, according to one or more embodiments.

### DETAILED DESCRIPTION

In order to find a suitable joining point, digital images of possible joining points are taken and such digital images may be processed by digital image processing which uses a digital computer and computer vision (CV)-algorithms programmed, historically, by hand to analyze the digital images and identify joining points. However, in real-world conditions, the imaging algorithms may struggle due to changes in illumination, inhomogeneous backgrounds, deviations in material and blurriness of the actual image, which may make it difficult for an image processing computer to find the suitable joining point. Disclosed herein are methods and systems for improving on identifying joining points, and thus, material joining by segmentation performed by neural networks.

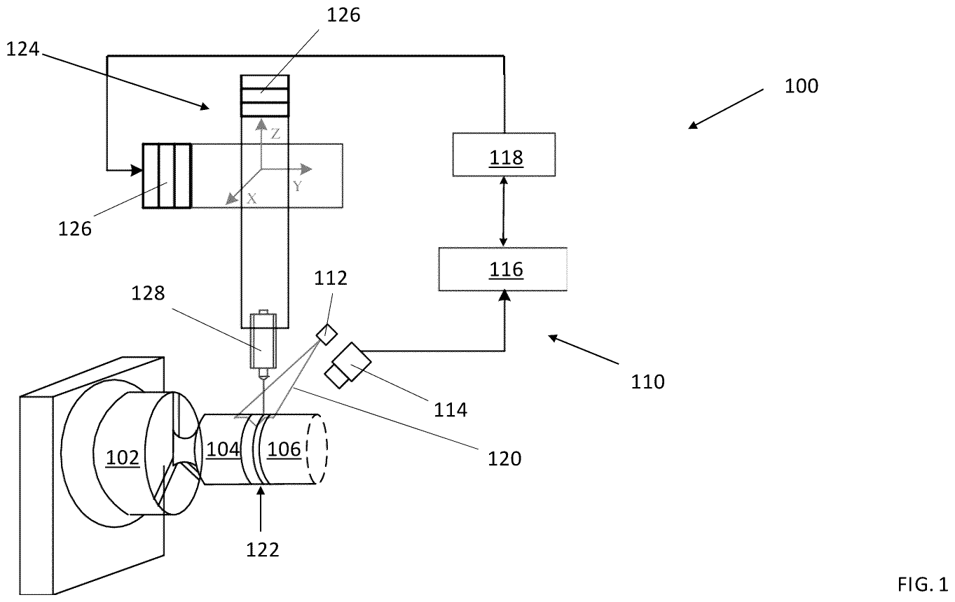

FIG. 1 shows a computer aided joining system 100. The system 100 consists of a clamp 102 that holds a first material 104 and a second material 106. The first and second material 104, 106 may be components of a clamping device, suction device, transport elements, or extraction device. Although FIG. 1 depicts the clamp 102 schematically as a chuck, which may or may not rotate on its axis, any appropriate work holding device for a given application may be used. First material 104 and second material 106 may be any suitable material for computer aided joining, for example, battery electrodes, motor stator hairpins. While further discussion may be with respect to only one or more of these examples, the disclosure is not so limited.

The system 100 may further include an optical assembly 110. The optical assembly 110 may include a light 112, a camera 114, an image processing computer 116, and a controller 118. The light 112 may be used to provide illumination for the camera 114. The camera 114, in conjunction with the image processing computer 116, constructs a digital image of the possible joining points 122. The image processing computer 116 is adapted to provide image segmentation, recognizing the edges or regions of the first and second material 104, 106 in the digital images, and to determine a suitable joining point from the possible joining points 122 in the digital images and transmits axis coordinates of the suitable joining point to the controller 118 that controls a joining apparatus 124.

In some embodiments, the digital image is taken by one or more image sensors, for example a sensor of camera 114, wherein the image sensor converts electromagnetic waves from the first and second materials into electrical signals. In some embodiments, the image sensor(s) include one or more of charge-coupled device (CCD), an active-pixel sensor (APS), an optical coherence tomography (OCT) sensor, a line scanner, a stereo and/or trifocal camera system, a time-of-flight camera, a light detection and ranging (LIDAR) sensor, and a RADAR (radio direction and ranging) sensor. In some embodiments, the APS is an image sensor with pixels, comprising: a photodetector and an active transistor. The APS may be a N-type metal-oxide-semiconductor (NMOS) APS, metal-oxide-semiconductor (MOS) APS, a complementary metal-oxide-semiconductor (CMOS) APS or a dynamic vison sensor in case the camera is an event camera, which comprises an imaging sensor that responds to local changes in brightness. In another example, the one or more image sensors may include a time-of-flight camera to acquire distance information to the first and second materials 104, 106 or other reference object.

The joining apparatus 124 may include the necessary mechanical means for the degrees of freedom needed for the mechanical joining process. For example, moving the joining apparatus 124 in X, Y, and Z directions, and or clamp 102, for example in a rotation axis (not shown) to the coordinates of the suitable joining point. This may include, appropriate belts, gears, motors, stepper motors, actuators, or the like, which are schematically represented generally as motors 126. The joining head 128 is adapted to join the first and second material 104, 106 and may include an appropriate joining means based on the material type, for example, joining head 128 may include one or more of a laser welder, an arc welder, an ultrasonic welder, a solvent dispenser, an actuated syringe, a solenoid, or the like. The controller 118 is adapted to move the joining head 128 to the determined suitable joining point, for example using motors 126 and to control the activation time and/or power of the joining head 128. The image processing computer 116 of the joining system 100 is adapted to perform image segmentation and determine the suitable joining point based on the digital image taken by the camera 114, which will be discussed further below.

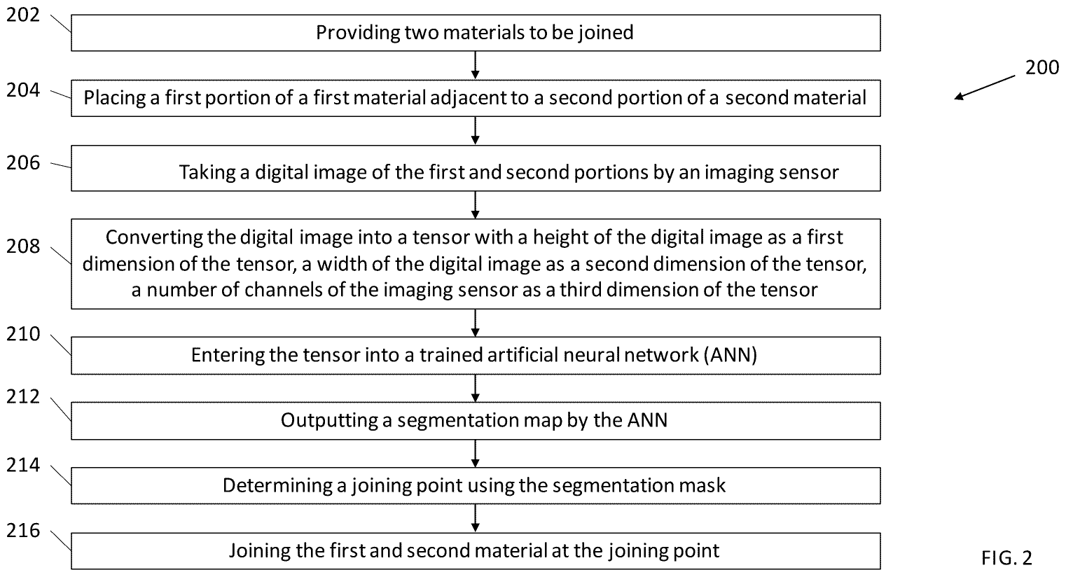

Methods for material joining, for example, the method 200 shown in FIG. 2, and described below, makes it possible to find the suitable joining points quickly and easily increasing the efficiency of system 100 and increasing throughput. Furthermore, the method allows for a faster production process with more precise dimensions and consistency of the materials, which uses only the required amount of joining material, thus minimizing waste, while simultaneously reducing energy consumption.

FIG. 2 shows a method 200 of example method steps for material joining. The method comprises the following steps, which may each be used individually or in combination with one or more of the other steps in the method 200. While the following method 200 is described as an overview, additional details and optional features are described further below.

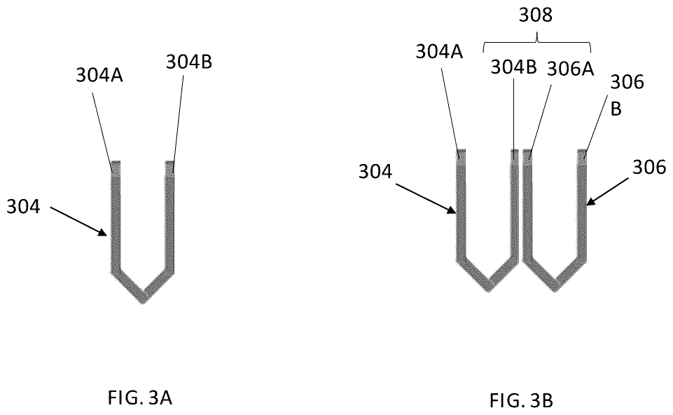

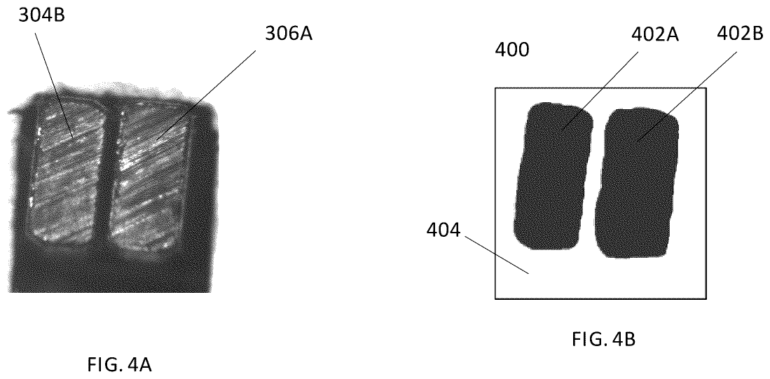

In a first step 202, two materials, for example first material 104 and second material 106, are provided. The two materials may be different or the same. In one example, the materials may be metals, including wires or strips. In another example, the materials may be plastics. As will be discussed below, the particular type of joining, e.g., welding, solvent welding, brazing, gluing, soldering, etc., will depend on the materials to be joined. For example, in one particular embodiment, the first and second materials 104, 106, are hairpins, and the joining is hairpin welding. The term “hairpin” is used in the industry for electrically conductive elements with a U-shape much like a hairpin, which may typically be used for joining windings in electrical motors. FIGS. 3A, 3B, 4A, and 4B, and the remainder of method 200 will be discussed with respect to joining hairpins as one example application. However, as noted previously, additional material and configurations may also be used. FIG. 3A shows an exemplary hairpin 304. The hairpins 304 comprise a wire that typically comprises copper. Each hairpin 304 comprises two portions 304A, 304B to be joined to adjacent hairpins.

In step 204, a first portion of a first material, e.g., first material 104 of FIG. 1, which may be embodied as a first hairpin, is placed adjacent to a second portion of a second material, e.g., second material 106 of FIG. 1, which may be embodied as a second hairpin. FIG. 3B shows an example of a first hairpin 304 and a second hairpin 306. A second portion 304B of the first hairpin 304 is placed adjacent to a first portion 306A of the second hairpin 306.

In step 206, a digital image is taken of the ends of the first and second portions by an imaging sensor, for example, the imaging sensor(s) discussed above with camera(s) 114. FIG. 4A shows an example digital image of a top view of a cross section of the second portion 304B of the first hairpin 304 and a cross section of the first portion 306A of the second hairpin 306 in the position at which the first and second hairpins 304, 306 will be joined. As can be seen in the photograph, the edges of the cross sections may be blurry or difficult to distinguish from the background due to the depth of field of the camera, optical distortion, inhomogeneous backgrounds, or the cross sections may be rough or have striations from material cutting, and/or the material may reflect light inconsistently due to angled surfaces, each of which would typically cause inaccuracies in prior art methods and systems.

The digital image includes a plurality of pixels that are arranged in rows and columns. Each pixel holds a value that represents the brightness of a given color. The digital image may be a raster image or bitmapped image. The digital image may also be preprocessed, which may include, for example, normalizing, cropping and/or scaling the digital image.

In step 208, the digital image is converted into a tensor with a height of the digital image as a first dimension of the tensor, a width of the digital image as a second dimension of the tensor, a number of communication paths that transmit digital signals (digital channels) of the imaging sensor as a third dimension of the tensor. The height of the digital image is represented by the rows of the pixels, the width of the digital image is represented by the columns of pixels, and the number of digital channels is represented by the pixel value. In some embodiments, the digital channels are communication paths of a single sensor, a plurality of sensors, and all the sensors of the optical assembly 110. In some embodiments, the number of dimensions of the tensor maybe higher, e.g., for a batch of digital images. Further, the particular order of the dimensions discussed herein is arbitrary and may be modified. The tensor structure and design should be chosen to be compatible with the input structure of the NN and vice versa.

The tensor is established by the outputs of each imaging sensor, namely sensor_1, . . . sensor_N. The tensor has a plurality of dimensions T(H, W, C, . . . ). For example, in a three dimensional tensor T(H,W,C), H is the image height, W is the image width, C is the total number of digital channels of all N imaging sensors. The digital channels contain the digital image information obtained from the one or more of the previously mentioned imaging methods about the detection area, which may include for example, a combination of the first and second material and any other background items, e.g., clamping device or other parts of the workpiece that will ultimately be distinguished. For this reason, it is preferred that the detection area be directed at the work area in which the materials will be joined such that the operating environment is captured. Further, if multiple imaging sensors are used, the imaging sensors may also be recorded, linked, and processed at once. For example, a first imaging sensor may include a camera, and a second imaging sensor may include a time-of-flight camera/sensor and their data combined.

In step 210, the tensor is entered into a trained neural network (NN). The NN may be, for example, an artificial NN (ANN), a Fully Convolutional Neural Network (FCN), a Vision Transformer (ViT), and/or a spiking neural network (SNN). The NN extracts features from the digital images to classify every pixel into classes or categories, and as discussed below, will predict a segmentation mask.

In step 212, a segmentation mask is outputted by the NN. The segmentation mask is determined by segmenting the digital image using a trained NN, the configuration and training thereof will be discussed further below. An example output of a segmentation mask 400 of the segmentation process is shown in FIG. 4B, in which regions of the segmentation mask 400 are segmented between target regions 402A, 402B (together “402”) and “separated” from the background 404 resulting in a “mask” of the segmented regions. That is, pixels are grouped by classes and pixels within the same class that will be represented by the same color or value. Adjacent segments are different in color, intensity, or texture from other segments or classes. Further, the generated segmentation mask may be further processed (Post Processing) depending on the application. Such post processing may include, for example improving the boundaries of the segmentation areas, correcting small errors, as described below.

During the forward pass, e.g., steps 208, 210 and 212, the NN is fed with data from the image sensor in form of input tensors, and reproduces the output tensors as the segmentation mask. The task of the NN is to find a mapping of the input tensor to the output tensor. The mapping in one example, is a chain of stacked simple non-linear transformations stored in the layers of the NN. The layers sequentially transform the input tensor into new representations, distill features, and make final decisions and predictions. The transformations are functions consisting of matrices (weights), vectors (biases), and non-linear activation functions.

During inference, e.g., steps 210 and 212, the trained NN may predict/generate the output tensors for the new data representing the segmentation mask. For post-processing, the tensors may be processed channel-by-channel and/or converted back into a digital image. Regions of the same class, e.g., segment, may have the same color or value in the output tensors. Segmentation can be a pixel-by-pixel classification.

In one configuration, the NN outputs the class probabilities or probability densities for a pixel to belong to a particular class (segment), some pixels may also be misclassified. Classical image processing like median filtering and morphological operators may further be used to help clean up the regions in the output image or in the respective channel of the output sensor (closing, deletions, etc.). The images cleaned this way can be analyzed using the connected components. The regions found in this way can be further analyzed by determining and sorting them based on their size and shape, as well as their contours and their respective properties such as convexity.

Once this is done, for example, predicted target regions 402, e.g., hair pins, found can be counted and, if necessary, missing pins can be signaled to a higher-level programable logic controller, image processing computer 116, and/or controller 118. If the number of expected predicted target regions 402 are located, for example one pin pair is detected for the case of welding two hair pins together, the corresponding regions, for example target regions 402, with their properties are passed to the final algorithm, which determines the exact location of the weld.

While FIG. 4B only shows two types of segments, target regions 402 and background 404, but additional segments may be also be determined. For example, additional segments identifying work holding apparatuses or reference surfaces. One or more digital channels are assigned to each point of the segmentation mask, with each digital channel m=1 to M representing distinct segments or regions contained with the segmentation mask.

In some embodiments, the digital image is segmented by semantic segmentation, instance segmentation, or panoptic segmentation. Semantic segmentation detects a belonging class for every pixel. A class may be a background or a foreground of the segmentation mask.

Instance segmentation identifies a belonging instance of the adjacent portions, for every pixel. Instance segmentation detects each pair of distinct adjacent portions in the digital image. Panoptic segmentation combines semantic and instance segmentation. Panoptic segmentation identifies the belonging class, for every pixel and distinguishes different instances of the same class.

The NN used in step 208 may reside in a software or other machine instructions in an image processing computer 116 of FIG. 1, or alternatively reside within a remote computer, server, or cloud infrastructure which is communicatively connected to image processing computer 116. Regardless of its location, the NN performs the image segmentation of the digital image.

The NN may be formed from connected nodes (neurons) arranged in a plurality of layers in which the input(s) to the NN are the first layer and the output is the last layer. In the example described above, the input to NN may include the digital image from the camera, e.g., numerical representations of the pixels associated with the image (e.g., the input image tensors discussed above) and the output of the NN may include the numerical representation of the segmented regions. FIG. 4B shows a graphical representation of such output, which may include individual pixel values representing the segmentation mask 400 segmentation mask 400. Within the NN, each neuron transmits a signal to another neuron that processes the signal according to its trained weight or bias and transmits the signal to another connected neuron. The signal is a real number, and the output of each neuron is computed by a non-linear function of the sum of its input signals. In some embodiments, the neurons have a weight that adjusts as the learning of the NN proceeds. The weight increases or decreases the strength of the signal at a connection, e.g., the output of any particular neuron and thus its contribution to the sum. Neurons may have a threshold such that a signal is sent only if the aggregate signal crosses that threshold. The neurons may be aggregated into layers that connect to either preceding or succeeding layers. Further, the number of neurons in each layer closer to the output is more abstracted than previous layers, e.g., having fewer neurons. Therefore, in one example, the first layer will include a neuron for each input channel, e.g., the digital pixel information from the input, while the output neurons (the last layer) will be reduced to the number of neurons needed to represent the output segmentation mask.

The NN model architecture may be a convolutional network having similar architecture as, for example, those described in: Ronneberger, et. al, Medical Image Computing and Computer-Assisted Intervention (MICCAI), Springer, LNCS, Vol. 9351: 234-241, 2015 (“U-Net”); J. Long, E. Shelhamer and T. Darrell, “Fully convolutional networks for semantic segmentation,” 2015 IEEE Conference on Computer Vision and Pattern Recognition (CVPR), 2015, pp. 3431-3440, doi: 10.1109/CVPR.2015.7298965; and E. Shelhamer, J. Long and T. Darrell, “Fully Convolutional Networks for Semantic Segmentation” in IEEE Transactions on Pattern Analysis and Machine Intelligence, vol. 39, no. 4, pp. 640-651, 1 Apr. 2017, doi: 10.1109/TPAMI.2016.2572683 (“FCN”), the entirety of each of which are incorporated by reference herein.

Disclosed methods and systems may further include training the NN to specially purpose the NN for segmenting the two materials to be joined. For example, the training, otherwise referred to as “learning” or “deep learning” may be performed prior to starting method 200 in order to generate the NN used at step 208. In some embodiments, the training may include utilizing a plurality of matched sets of input photographs (similar to FIG. 4A) and their previously generated respective segmentation masks (similar to FIG. 4B) as inputs and outputs (a training set) to the NN architecture such that the NN updates weights and biases associated with the plurality of neurons to minimize one or more errors associated with the training set, e.g., the difference between the known segmentation mask and the output of the NN. The training set may be a supervised training set in which personnel review the input photographs and manually create the segmentation masks associated with the input photograph. When the segmentation masks are manually created, the digital images from the manual segmentation masks are then converted into an expected tensor (output tensor) that has the same width and height as the digital image, with the number of channels equal to the number of classes. The training is performed by iteratively minimizing the error between the actual and predicted output tensor, by adapting the NNs weights and biases thus finding the mapping from input to output tensors.

Providing a sufficient number of training sets to the NN, the number of which will depend on the particular materials being joined and their orientations and mounting environment, will result in a trained, specially purposed, NN for use in step 208 for the appropriate materials to be joined.

Further, the training matched sets (i.e., training sets, or training data) may include a plurality of data subsets. For example, if there is a sufficient number of training sets the available data may be split into one or more of a training dataset, a dev dataset, and a test dataset. In one example, the training dataset may be used by an optimizer to minimize an error associated with the training dataset by adjusting its weights to correctly classify each pixel within the digital image (fitting the model) as the initial training of the NN. The dev dataset may be used to evaluate the model while training, and checking if the model is generalizing from the training data or if it is just “memorizing.” For example, by comparing the output of dev dataset (resulting from passing its inputs to the NN) to the known match set segmentation mask. The goal is to train the model until the error associated with the dev dataset reaches a minimum. When running lots of trials with slightly different models (hyperparameter tuning) the dev dataset may be overfitted. Therefore, the test dataset is used to finally evaluate the model and check its generalization ability, to mitigate the chance of overfitting on the dev dataset when running lots of trials with slightly different models (hyperparameter tuning).

The NN, in one example, is trained on one or more matched sets of input photographs and their previously generated respective segmentation masks. Or alternatively using an unmatched input using automatic or manual feedback. In other examples, the NN is trained manually as described below.

A first step in training the NN may include taking a digital image from the coverage area.

A second step in training the NN is labeling the digital image: The regions of interest in the digital image, e.g., joining point, are determined either manually or with the help of an annotation program.

A third step in training the NN may include converting the labeled digital image to a tensor.

A fourth step of training the NN may include entering the tensor into the untrained NN that outputs a true segmentation mask created through suitable encoding. The training of the NN results in a trained NN that transforms the coverage area into corresponding segments of the region of interest. Transforming the coverage area into corresponding segments includes taking each pixel, which are all unique, and subdividing them into fewer segments (m to M) based on the number of segments to identify.

The trained NN transforms an unlabeled tensor into a segmentation mask, e.g., the output of the NN.

In a fifth step, the error between the true segmentation mask and an estimated segmentation mask is minimized by changing the parameters of the NN, for example the biases/weights of the nodes through the training optimization process. For example, minimizing the error may include the calculus chain rule to trace the error signal from the output to the input of the NN and calculate the corresponding gradients, as well as an optimization algorithm to iteratively improve the mapping, such as a gradient descent.

As mentioned above, the disclosed embodiments are described with reference to joining hairpins as the first and second example materials 104, 106. FIG. 4B shows a segmentation mask of the digital image of FIG. 4A as the output of the NN from step 208. FIG. 4B shows that the portions of the hairpins as target regions 402 in the segmentation mask are well localized by their shape and orientation. The ends of the hairpins, representing the foreground, are well distinguished from the background 304. Recognizing the target regions 402 from the background 404 increases the accuracy of follow-on steps, e.g., step 212, discussed further below.

In step 214, a joining point is determined using the segmentation mask. The joining point is determined using the output of the NN as an input, that is, the segmentation mask is used to determine where the joining between the two materials should take place, which will be translated by the system 100, e.g., image processing computer 116 and/or controller 118, into appropriate axis coordinates or other appropriate machine instructions, e.g., G-code, RS-274 or the like.

The segmentation mask breaks down the coverage area into areas belonging to the first and second material for joining, and/or other areas. Once the segmentation mask is output, they may be further evaluated to determine the desired joining locations. For example, if using a center of gravity method, the areas belonging to the first and second material are evaluated by calculating the center of gravity of individual regions or the contours of the individual regions.

The information about the center of gravity and contours of the individual regions are then processed to find exemption of certain regions, e.g., cross section of the first and second material for calculation of the respective centers and/or the respective contours.

Based on the obtained information about the center of gravity and contours of the individual regions, certain process parameters, such as the positioning of the laser beam can be adjusted. In particular, these process parameters are positioning of the laser strand based on the center of gravity, center points, and descent along a contour. Further process parameters include line energies to be introduced, feed speed, laser power, beam deflection, and motion frequency.

In step 216, the first and second material are joined at the determined joining point. In some embodiments, the first and second material may be joined by laser welding. The laser welding may be performed by a laser welding machine.

In some embodiments, the first and second material are hairpins placed in a stator and the joining points of the hairpins are welded to form a stator winding, for example, by executing steps 206, 208, 210, and 212 of method 200. After welding of the joining points, a mechanical connection, and/or an electrically conductive connection between the portions is created. The welding of the portions of the hairpins next to each other creates a mechanically and electrically interconnected, continuous stator winding, or portion thereof. The joining point can be welded by gas welding, arc welding, resistance welding, energy beam welding, ultrasonic welding, solvent welding, gluing, or the like.

For example, gas welding may include oxyfuel welding (oxyacetylene welding). For the gas welding, acetylene is combusted in oxygen which produces a flame for the gas welding with a temperature of about 3100° C. (5600° F.). Arc welding, may for example, use a power supply to create and maintain an electric arc between an electrode and the portions of the materials forming the joining point. The power supply uses either direct current (DC) or alternating current (AC), and consumable or non-consumable electrodes. The welding region may be protected by an inert or semi-inert gas, which is called the shielding gas. Furthermore, a filler material may be used.

Resistance welding, for example, may include welding in which the contact between the two portions form a resistance and a current is passed through the resistance that generates heat. Then, a high electrical current (1000-100,000 A) is passed through the resistance which forms small pools of molten metal at the joining point.

Energy beam welding, for example, may include, for example, laser beam welding and electron beam welding. Laser beam welding employs a highly focused laser beam. Electron beam welding uses an electron beam and is done in a vacuum.

Ultrasonic welding, for example, may include connecting the materials by vibrating them at high frequency and under high pressure.

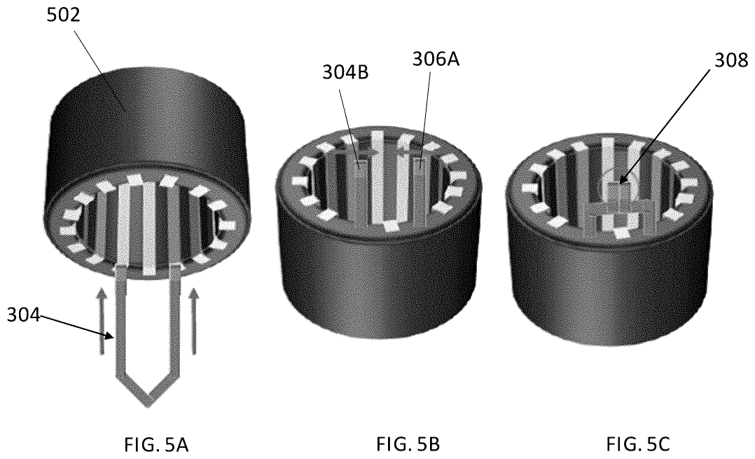

In some embodiments, the two materials (e.g., first and second materials 104, 106), are hairpins for manufacturing a stator. FIG. 5 shows an example in which two or more hairpins are added to a stator 502. The stator 502 is the stationary part of electric generators, electric motors, sirens, mud motors, or biological rotors. The stator consists of an insulating material and stator windings. For manufacturing the stator windings, the hairpins are introduced into the stator to join adjacent conductors or winding conductors.

For example, electrically conductive hairpins are introduced into holes of a stator parallel to one another such that portions of adjacent hairpins are placed adjacent to each other as shown, for example, in FIGS. 5A, 5B, and 5C.

FIG. 5A shows a stator 502 of an electric motor. The stator 502 comprises holes running parallel to an axis of the stator 502 for insertion of the hairpins 304. The hairpins 304 are shaped like a clip comprising two portions. The hairpins 304 are made of electrically conductive material. The hairpins 304 are introduced into the holes of the stator 502 such that the portions of the hairpins 304 stick out of the holes of the stator 502.

FIG. 5B shows the stator 502 of FIG. 5A and a second portion 304B of a first hairpin and a first portion of a second hairpin 306A, wherein the first and second hairpin are placed adjacent to each other. The portions 304B, 306A are then placed next to each other. If the portions 304B, 306A are not in the intended joining location, the portions may be physically maneuvered or adjusted such that the cross sections of the portions 304B, 306A are next to each other and, for example, in the same plane, as shown by the arrows.

Following alignment, the joining points 308 are welded to form a stator winding, for example, by executing steps 206, 208, 210, and 212 of method 200. After welding of the joining points 308, a mechanical connection, and an electrically conductive connection between the segments 304A, 304B is created. The welding of the segments 304B, 306A of the hairpins 304 next to each other creates a mechanically and electrically interconnected, continuous stator winding, or portion thereof.

The method steps in any of the embodiments described herein are not restricted to being performed in any particular order. Also, structures mentioned in any of the method embodiments may utilize structures mentioned in any of the device embodiments. Such structures may be described in detail with respect to the device embodiments only but are applicable to any of the method embodiments.

Unless specific arrangements described herein are mutually exclusive with one another, the various implementations described herein can be combined in whole or in part to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for joining materials, comprising:
providing two materials;
placing a first portion of a first material adjacent to a second portion of a second material;
taking a digital image of the first and second portions by an imaging sensor;
converting the digital image into a tensor, the tensor comprising at least first, second, and third dimensions, wherein the first dimension comprises a height of the digital image, the second dimension comprises a width of the digital image, and the third dimension comprises a number of digital channels of the imaging sensor,
entering the tensor into a trained neural network (NN);
outputting a segmentation mask by the NN,
determining a joining point using the segmentation mask; and
joining the first and second material at the joining point.

2. The method of claim 1, wherein the first and/or second materials comprise a metal.

3. The method of claim 2, wherein the joining comprises welding, brazing, and/or soldering.

4. The method of claim 3, wherein the welding comprises gas welding, arc welding, resistance welding, energy beam welding, or ultrasonic welding.

5. The method of claim 1, wherein the first and/or second material comprises a wire.

6. The method of claim 1, wherein the joining point is determined by thresholding, connected-components, contours, morphological segmentation, or Gaussian mixture.

7. The method of claim 6, wherein the thresholding comprises histogram shape-based thresholding, clustering-based thresholding, entropy-based thresholding, object attribute-based thresholding, and spatial thresholding.

8. The method of claim 1, wherein the digital image is segmented by at least one of semantic segmentation, panoptic segmentation, and instance segmentation.

9. The method of claim 1, wherein the joining point is determined by determining at least one of a distance (gap), a convexity, a boundary contour, and a centroid (center point) of the first and second portions.

10. The method of claim 1, wherein the neural network is trained using deep learning.

11. The method of claim 1, wherein the training of the NN comprises training at least one of a convolutional NN, a Fully Convolutional Neural Network (FCN), a Vision Transformer (ViT), and a SNN.

12. The method of claim 1, wherein the training comprises reducing an error associated with the training set.

13. The method of claim 1, wherein the first and second material are electrically conductive hairpins, and the joining comprises hairpin welding for manufacturing a stator, wherein:
placing a first portion of a first material adjacent to a second portion of a second material comprises introducing the hairpins into a stator such that portions of adjacent hairpins are placed adjacent to each other;
determining a joining point comprises determining a shape and an orientation of the portions placed adjacent to each other from the segmentation mask; and
joining the first and second material comprises welding the joining points to form a stator winding from the welded hairpins.

14. The method of claim 13, wherein the digital images are taken from cross sections of the portions placed adjacent to each other.

15. The method of claim 1, further comprising preprocessing the digital image by normalizing cropping, and/or scaling the digital image.

16. The method of claim 1, wherein the NN is an artificial NN or a spiking neural network.

17. A system for joining materials, comprising:
a holder adapted to hold at least a first and a second material, such that a first portion of the first material is placed adjacent to a second portion of the second material;
a camera adapted to take digital images of the first and second portions;
an image processing computer adapted to process the digital images into a segmentation mask using a neural network (NN), and to determine joining points of the materials; and
a joining apparatus adapted to join the first and second material at the joining points.

18. The system of claim 17, wherein the joining apparatus is a welding apparatus, brazing apparatus, or soldering apparatus.

19. The system of claim 17, wherein the welding apparatus is a gas welding apparatus, arc welding apparatus, resistance welding apparatus, energy beam welding apparatus, or ultrasonic welding apparatus.

20. The system of claim 17, wherein
the holder is a stator with holes that hold electrically conductive hairpins parallel to one another such that portions of adjacent hairpins are placed adjacent to each other, and the joining apparatus is a hairpin welding apparatus.
